(19) United States
(12) Patent Application Publication
(10) Pub. No.: US 2011/0285823 A1
(43) Pub. Date: Nov. 24, 2011

(54) Device and Method for the Three-Dimensional Optical Measurement of Strongly Reflective or Transparent Objects

(75) Inventors: David Nabs, Burg (DE); Kai Gensecke, Burg (DE)

(73) Assignee: AIMESS SERVICES GMBH, Burg (DE)

(21) Appl. No.: 13/133,239

(22) PCT Filed: May 7, 2009
(86) PCT No.: PCT/EP2009/003275

§ 371 Date: Aug. 5, 2011

(30) Foreign Application Priority Data
Dec. 19, 2008 (DE) 10 2008 064 104.9

(51) Int. Cl. H04N 13/02

(52) U.S. Cl. 348/46; 348/E13.074

(57) ABSTRACT

The invention relates to a device for three-dimensionally measuring an object, comprising a first projection device having a first infrared light source for projecting a displaceable first pattern onto the object, and at least one image capturing device for capturing images of the object in an infrared spectral range. The invention further relates to a method for three-dimensionally measuring an object, comprising the steps of projecting a first infrared pattern onto the object using a first projection device having a first infrared light source; and capturing images of the object using at least one image capturing device sensitive to infrared radiation, wherein the pattern is shifted between image captures.

### FIELD OF THE INVENTION

The invention relates to a device and a method for the three-dimensional measurement of objects with a topometric measurement method.

### STATE OF THE ART

The three-dimensional registration of object surfaces using optical triangulation sensors according to the principle of topometry is adequately known. In this connection, for example, different stripe patterns are projected onto the object to be measured, observed by one or more cameras and then analyzed with computer assistance. The analysis methods are, for example, phase-shift methods, the coded light approach or the heterodyne method.

A projector illuminates the measurement object sequentially in time with patterns of parallel light and dark stripes of the same or different width. The projected stripe pattern is deformed, depending on the shape of the object and the line of sight. The camera or cameras register the projected stripe pattern at a known angle of view to the projection direction. An image is captured with each camera for each projection pattern. The borderline (edge) between a light and a dark stripe is decisive for analyzing the measurements.

The pattern is displaced across the object (scanned) in order to measure the entire object. This results in a chronological sequence of different brightness levels for each image point of all cameras. The image coordinates in the camera image are known for a given object point. The number of stripes can be calculated from the sequence of brightness levels that were measured from the image sequence for each camera image point. In the simplest case, this takes place with a binary code (e.g., a Gray code) that identifies the number of the stripe as a discrete coordinate in the projector.

Greater precision can be achieved with the so-called phase-shift method, because it can determine a non-discrete coordinate whereby the phase position of a modulated signal is determined by point-by-point intensity measurements. The phase position of the signal is thereby shifted by a known value at least two times while the intensity is measured at one point. The phase position can be calculated from three or more measured values. The phase-shift method can be used either in addition to a Gray code or as an absolutely measuring heterodyne method (with a plurality of wavelengths).

The fundamentals and practical applications of such topometric measurement methods are described in detail, for example, in Bernd Breuckmann: “Bildverarbeitung and optische Messtechnik in der industriellen Praxis”, 1993, Franzis-Verlag GmbH, Munchen.

If, however, one wants to measure objects that are very strongly reflective, such as the painted body of a car, for example, or that are even transparent to visible light, such as glass surfaces, for example, the previous measurement systems based on stripe projection are not able to register such objects topometrically because no projection pattern is visible on the surface of such objects.

An approach for checking strongly reflective surfaces is known from DE 202 16 852 U1, whereby this approach can detect bumps or dents by means of reflectometry or deflectometry. Due to the measurement principle, however, this device is unsuitable for registering an object with sufficient precision or with the necessary resolution because the lateral resolution is too low.

The quality of the measurement that results from the three-dimensional measurement of objects by using stripe projection greatly depends on the contrast between the projection and the ambient light.

### DESCRIPTION OF THE INVENTION

In light of the disadvantages of the state of the art, the problem forming the basis of the invention is to provide a device for the three-dimensional optical measurement of objects that are transparent for visible light or that strongly reflect light with a topometric measurement method that supplies good contrast conditions in the projection pattern on the objects.

The cited problem is solved by the device according to claim 1 and the method according to claim 10.

The device according to the invention for the three-dimensional measurement of an object comprises a first projection device having a first infrared light source for projecting a displaceable first pattern onto the object and at least one image capturing device for capturing images of the object in an infrared spectral range.

The use of infrared light for projecting the pattern has the advantage that the projected pattern leaves an impression of itself as a heat distribution on the object to be measured, i.e., the corresponding surfaces of the object illuminated with infrared radiation by the projection device differ from the surfaces of the object not illuminated in this way in that there is a temperature difference. This temperature difference, in turn, is expressed in a different intensity of the radiant emission in the infrared wavelength range, particularly the so-called heat radiation that, e.g., can be captured with an infrared camera.

It must be observed thereby that the wavelength range of the irradiated infrared pattern does not necessarily match the wavelength range that is emitted by the object. The same also applies to the wavelength range for which the image capturing device is sensitive.

The projected pattern can, in particular, be formed in a point-like, line-like or area-like manner.

A further development of the device according to the invention lies in the fact that it can comprise a second projection device with a second infrared light source for projecting a displaceable second pattern onto the object. This approach allows combinations of the two patterns to be achieved, whereby in particular the second projection device can be arranged such that the second pattern can be projected from a different direction and at a different angle.

Another further development lies in the fact that the first infrared light source of the first projection device has a first emission surface and/or whereby the second infrared light source of the second projection device can have a second emission surface. Combined with a high emission capability of the heated emission surface, the generated heat is quickly and efficiently given off as infrared radiation.

Another further development lies in the fact that the respective emission surface can be heated by a respective resistance heater. Quick direct modulation of the IR radiation is made possible by the electric heating power.

Another further development lies in the fact that the respective emission surface itself can define the pattern to be projected, or that the respective pattern can be defined by a respective pattern element with surfaces transparent to infrared light and surfaces not transparent to infrared light, whereby the respective pattern element can be arranged between the respective emission surface and the object.

Another further development lies in the fact that the respective pattern is a stripe pattern. This has the advantage that the edge between the stripes is a straight line whose deformation on the object is captured with the image capturing device.

Another further development lies in the fact that the device furthermore can comprise an analysis device for analyzing the images captured by the image capturing device. This analysis device can, e.g., be implemented by means of a computer unit on which a suitable program for topometric analysis of the captured images is executed. In particular, the corresponding surface form of the object can, e.g., be back-calculated from the deformation of a linear edge.

Another further development lies in the fact that the respective projection device can have a cylinder that is provided with the emission surface, whereby the cylinder can be rotated around its cylindrical axis. This has the advantage that a displaceable pattern (for example, a stripe pattern of the emission surface or a pattern element) can be projected onto the object in a simple manner.

Another further development lies in the fact that the image capturing device can be sensitive to infrared radiation with a wavelength in the range from 1 μm to 1 mm, preferably in the range from 3 μm to 50 μm, more preferably in the range from 3 μm to 15 μm, most preferably in the range from 3 μm to 5 μm or 8 μm to 14 μm. In particular, this allows the use of infrared cameras that are used for thermography and that are sensitive to the middle infrared range (3-15 μm). For the spectral range from 8 to 14 μm, gallium-arsenide detectors or cadmium-mercury-telluride detectors can be used, for example.

The abovementioned problem is furthermore solved by the method according to the invention for the three-dimensional measurement of an object having the steps: projecting a first infrared pattern onto the object with a first projection device with a first infrared light source, and capturing images of the object with at least one image capturing device sensitive to infrared radiation, whereby the pattern is shifted between the image captures.

A further development of the method according to the invention lies in the fact that it can have the following additional step: projecting a second infrared pattern onto the object with a second projection device with a second infrared light source.

Another further development lies in the fact that the respective pattern can be a stripe pattern.

Another further development lies in the fact that each pattern can be displaced across the object by the respective projection device at a respective stipulated speed. In this way, the object is scanned, whereby images shifted in time are made with the image capturing device (camera).

Another further development lies in the fact that the respective projection device can have a cylinder that is provided with a respective emission surface, whereby the cylinder can be rotated around its cylindrical axis.

Another further development lies in the fact that the at least one image capturing device can be triggered with the projection device. In this way, predetermined sequences of combinations of the projected patterns onto the surface can be captured.

Another further development lies in the fact that the method can comprise a further step: analysing the images captured by the image capturing device in an analysis device with a topometric analysis method. In this way, the three-dimensional surface structure of the object can be analyzed.

The various further developments can be used independently of one another or combined with one another.

Further preferred embodiments of the invention are described in the following with reference to the drawings.

### BRIEF DESCRIPTION OF THE DRAWINGS

FIG. 1 shows a first embodiment of the device according to the invention.

FIG. 2 shows a second embodiment of the device according to the invention.

### DESCRIPTION OF THE EMBODIMENTS

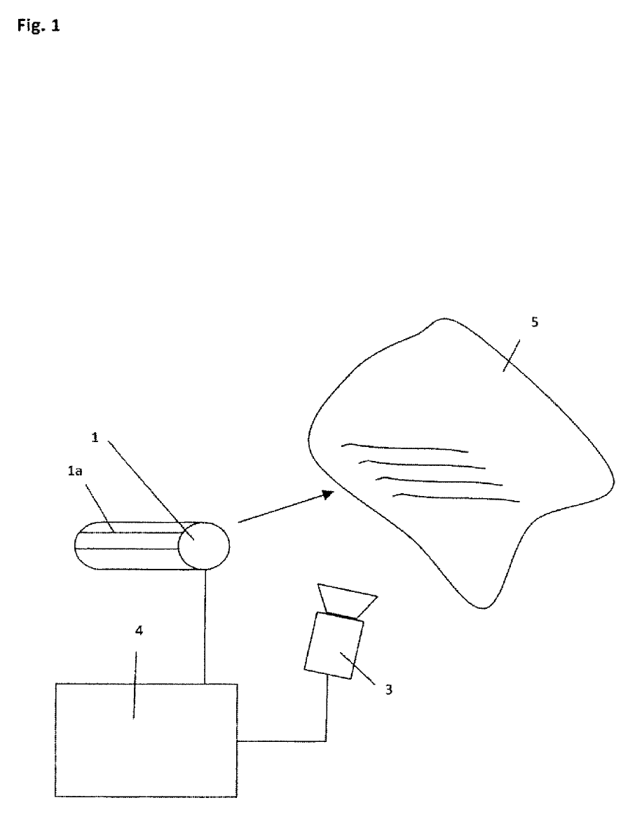

FIG. 1 shows a first embodiment of the device according to the invention for the three-dimensional optical measurement of a transparent or strongly reflecting object 5 with a topometric measurement method having at least one projector 1 with a high infrared light intensity in order to obtain good contrast conditions.

The infrared light source 1a of the projector 1 is based on a resistance heater that heats an emission surface 1a. Combined with a high emission capability of the heated emission surface, the generated heat is quickly and efficiently given off as infrared radiation. Quick direct modulation of the IR radiation is furthermore made possible by the electric heating power. The emission surface in this example thereby directly forms the stripe pattern that is to be projected. Another possibility lies in that a mask with the pattern is arranged between the emission surface and the object.

Because the stripe pattern must wander across the surface of the object 5, the device according to the invention provides a displaceable stripe pattern that can rotate, for example, in the form of a cylinder 1 that is provided with the emission surface, whereby the cylinder 1 can rotate around its cylindrical axis.

The object 5 with the projected pattern is captured by an infrared camera 3. The signals or data from the camera are then fed to an analysis device 4 (e.g., computer) on which a program for topometric analysis is executed.

Depending on the material of the object 5 and its thermal conductivity, the intensity of the infrared radiation from the projection device 1 can be selected such that the temperature difference is, on the one hand, large enough to register an edge (a difference) between an illuminated and an non-illuminated surface with the image capturing device (camera) 3, but on the other hand small enough that this edge is not substantially softened during the capturing due to thermal diffusion. This is based on the fact that the length of time for the thermal diffusion is essentially inversely proportional to the temperature difference. With the selection of a suitable intensity of the infrared radiation and a suitable length of time between temporally adjacent capturings, a good contrast level can be achieved between the illuminated and the non-illuminated areas of the object.

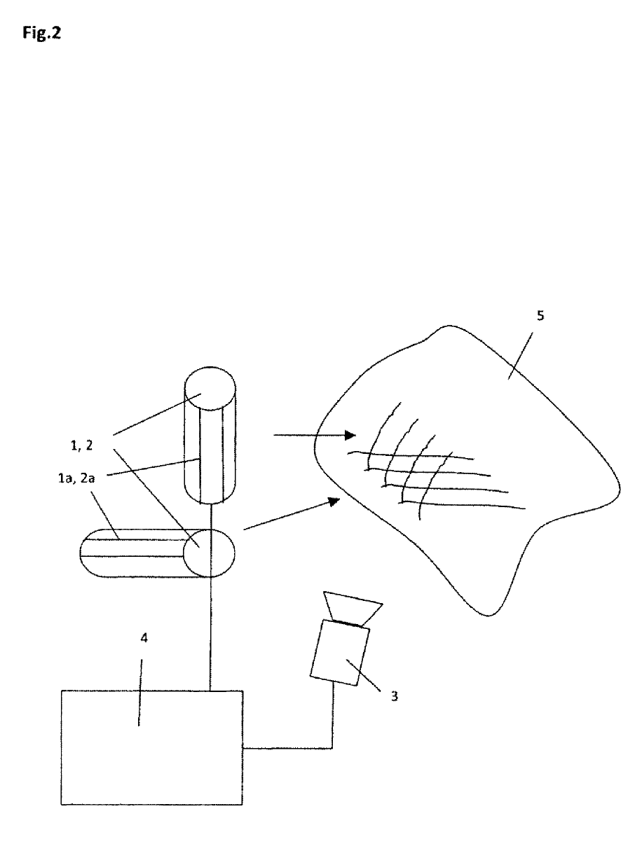

FIG. 2 shows a second embodiment of the device according to the invention. Reference numbers that are the same in FIG. 1 and FIG. 2 indicate the same elements.

The second embodiment has a second projector 2 not found in the first embodiment as shown in FIG. 1, whereby this second projector 2 is likewise in the form of a cylinder. The two cylindrical emission patterns that rotate with respect to one another at a defined angle are projected onto the object surface. Each cylinder thereby rotates, each at a defined speed, around its particular cylindrical axis. The new projection pattern that results in this way has characteristics that allow faster analysis with a high resolution. For example, special patterns arise on the surface that depend on the rotational speed and the angle between the cylinders 1, 2 and that can be adjusted in a defined manner in order to allow better analysis of specific features of the object surfaces.

The camera 3 (capturing device) is furthermore triggered with the projectors 1, 2 in such a way that variation of the triggering is sufficient to allow additional special patterns on the surface to be analyzed.

1. Device for the three-dimensional measurement of an object comprising:
a first projection device having a first infrared light source for projecting a displaceable first pattern onto the object; and
at least one image capturing device for capturing images of the object in an infrared spectral range.

2. Device in accordance with claim 1 comprising a second projection device having a second infrared light source for projecting a displaceable second pattern onto the object.

3. Device according to claim 2 wherein the first infrared light source of the first projection device has a first emission surface and/or wherein the second infrared light source of the second projection device has a second emission surface.

4. Device according to claim 3 wherein the respective emission surface can be heated by a respective resistance heater.

5. Device according to claim 3 wherein the respective emission surface itself defines the pattern to be projected, or wherein the respective pattern is defined by a respective pattern element with surfaces transparent to infrared light and surfaces not transparent to infrared light, wherein the respective pattern element is arranged between the respective emission surface and the object.

6. Device according to claim 1 wherein the respective pattern is a stripe pattern.

7. Device according to claim 1 furthermore comprising an analysis device for analyzing the images captured by the image capturing device.

8. Device according to claim 3 wherein the respective projection device has a cylinder that is provided with the emission surface, wherein the cylinder can be rotated around its cylindrical axis.

9. Device according to claim 1 wherein the image capturing device is sensitive to infrared radiation with a wavelength in the range from 1 μm to 1 mm, preferably in the range from 3 μm to 50 μm, more preferably in the range from 3 μm to 15 μm, most preferably in the range from 3 μm to 5 μm or 8 μm to 14 μm.

10. Method for the three-dimensional measurement of an object with the steps:
projecting a first infrared pattern onto the object with a first projection device with a first infrared light source;
capturing images of the object with at least one image capturing device sensitive to infrared radiation;
wherein the pattern is shifted between the image captures.

11. Method according to claim 10 with the additional step:
projection of a second infrared pattern onto the object with a second projection device with a second infrared light source.

12. Method according to claim 11 wherein the respective pattern is a stripe pattern.

13. Method according to claim 11 wherein each pattern is displaced across the object by the respective projection device at a respective stipulated speed.

14. Method according to claim 13 wherein the respective projection device has a cylinder that is provided with a respective emission surface, wherein the cylinder is rotated around its cylindrical axis.

15. Method according to claim 13 wherein the at least one image capturing device is triggered with the projection devices.

16. Method according to claim 10 with the additional step:
analysing the images captured by the image capturing device in an analysis device with a topometric analysis method.
